(19) United States
(12) Patent Application Publication
(10) Pub. No.: US 2012/0311843 A1
(43) Pub. Date: Dec. 13, 2012

(54) APPARATUS AND METHOD FOR MOUNTING WHEELS

(76) Inventor: MICHAEL SALES, SR., Cumming, GA (US)

(21) Appl. No.: 13/158,702

(22) Filed: Jun. 13, 2011

(51) Int. Cl. B60B 29/00; B23P 17/00

(52) U.S. Cl. 29/464; 29/273

(57) ABSTRACT

Magnesium or aluminum wheels may be conveniently mounted on a vehicle by using a wheel guide for attaching the wheel to a vehicle. The guide may include a hollow cylindrical stud attachment portion having an outside diameter approximately equal to a diameter of aligning portions of wheel nuts. The stud attachment portion may have an opening with an inside diameter approximately equal to an outside diameter of a wheel mounting stud of the vehicle and a depth greater than a length of the stud.

### BACKGROUND OF THE INVENTION

The present invention generally relates to vehicle wheels, and more particularly, to methods and apparatus for mounting wheels on a vehicle.

A typical automotive aluminum or magnesium (mag) wheel may have mounting holes which are larger than studs on which the wheels may be mounted. Such an arrangement is illustrated in FIG. 1. A mag wheel 12 may have mounting holes 13 which may have a diameter about twice as great as a diameter of the studs 16. The mag wheel 12 may be held in place with wheel nuts 22 and washers 23. Aligning portions 22-1 of the wheel nuts 22 may fit snugly in the holes 13 so that the holes 13 are concentric with the studs 16.

It may be seen that the mag wheel 12 must be initially positioned so that the holes 13 are approximately concentric with the studs 16. This initial positioning must be done so that the aligning portions 22-1 of the mounting nuts 22 may be inserted into the holes 13. This initial positioning has heretofore been performed by a person carefully holding the mag wheel 12 in an initial aligned position while installing the wheel nuts 22 onto the studs 16.

As can be seen, there is a need for a system that may preclude a need for a person to hold a wheel in such a carefully aligned position prior to placing wheel nuts on the studs.

### SUMMARY OF THE INVENTION

In one aspect of the present invention, a wheel guide for attaching a wheel to a vehicle with wheel nuts having aligning portions may comprise a hollow cylindrical stud attachment portion having an outside diameter approximately equal to a diameter of the aligning portions of wheel nuts, the stud attachment portion having an opening with an inside diameter approximately equal to an outside diameter of a wheel mounting stud of the vehicle and a depth greater than a length of the stud.

In another aspect of the present invention, a wheel guide for attaching a wheel to a vehicle with wheel nuts having aligning portions may comprise a hollow cylindrical stud attachment portion having an outside diameter approximately equal to a diameter of the aligning portions of wheel nuts, the stud attachment portion having internal threads configured to engage with threads of a wheel mounting stud of the vehicle.

In still another aspect of the invention, a method for mounting a wheel on a vehicle may comprise the steps of: providing for placement of a wheel guide on a wheel mounting stud of the vehicle; providing for positioning the wheel so that the wheel guide passes through a hole of the wheel; and providing for pushing the wheel on the guide so that all holes of the wheel overlie their respective wheel mounting stud and so that the holes are aligned concentrically with the studs.

These and other features, aspects and advantages of the present invention will become better understood with reference to the following drawings, description and claims.

### BRIEF DESCRIPTION OF THE DRAWINGS

FIG. 1 is an illustration of a typical wheel attachment mechanism for mag wheels in accordance with the prior art;

FIGS. 2, 3 and 4 are perspective views of a method for mounting mag wheels on a vehicle in accordance with an embodiment of the invention;

FIG. 5 is a partial cross-sectional view of a wheel guide in accordance with an embodiment of the invention;

FIG. 6 is a partial cross-sectional view of a wheel guide in accordance with a second embodiment of the invention; and

FIG. 7 is a partial cross-sectional view of a wheel guide in accordance with a third embodiment of the invention.

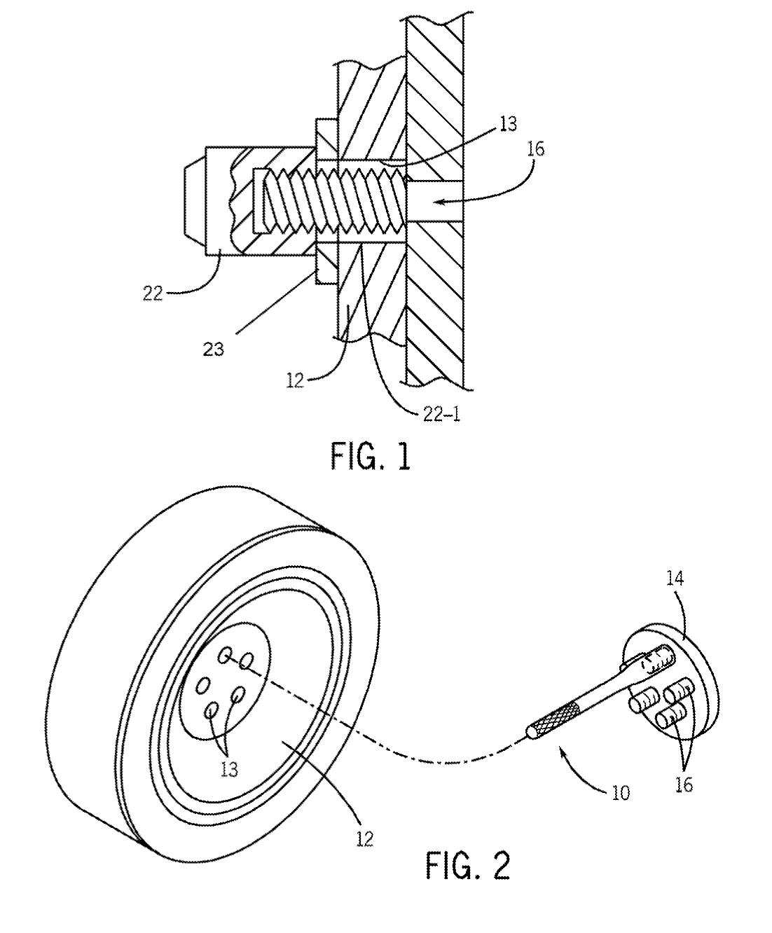

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide wheel guides which may be placed on a stud and which may support a wheel in a desired aligned position prior to installation of wheel nuts.

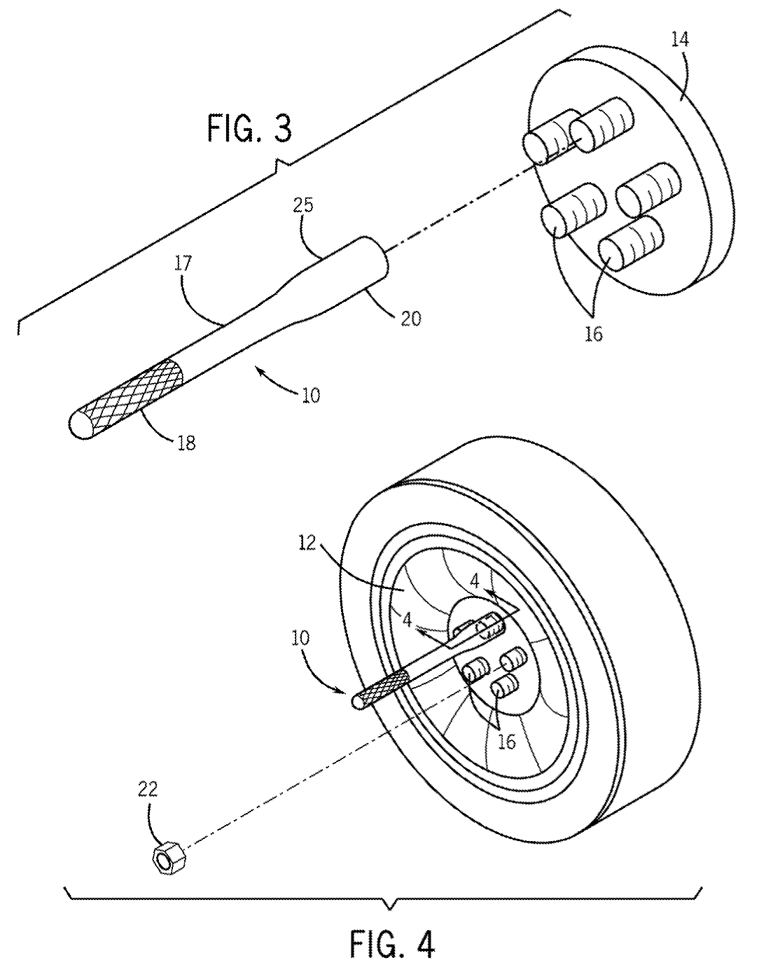

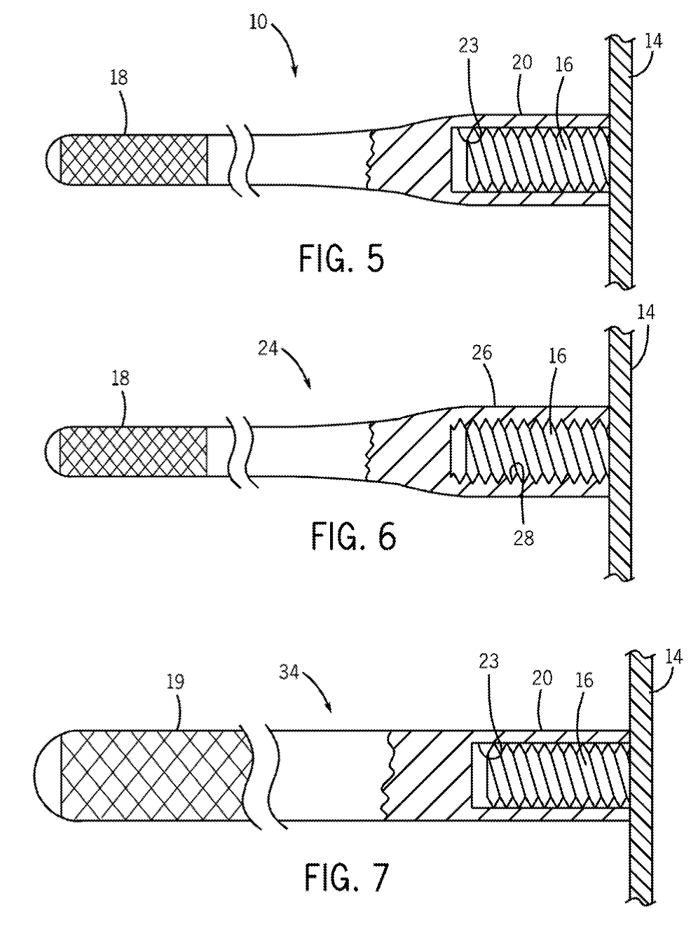

Referring now to FIGS. 2 through 4, a system for installing mag wheels in accordance with the invention is illustrated. A wheel guide 10 may be placed on one of the studs 16. The wheel 12 may be moved toward a vehicle hub 14 so that the wheel guide 10 may enter one of the holes 13. The wheel 12 may be moved further toward the vehicle hub 14 until all of the studs 16 are in positions within one of the holes 13.

In an exemplary embodiment, the wheel guide 10 may comprise a handle 17 and a stud attachment portion 20. The handle 17 may have a diameter smaller than a diameter of the holes 13 of the mag wheel 12. Advantageously, the wheel guide 10 may be about 12 inches to about 15 inches long. The stud attachment portion 20 may have an outside diameter almost the same as the diameter of the aligning portion 22-1 of the wheel nut 22. More particularly, the stud attachment portion 20 may have a diameter that is about 0.010 inch to about 0.020 inch smaller than the diameter of the aligning portion 22-1. The stud attachment portion 20 may be configured as a hollow cylinder. An opening 23 may be provided in the stud attachment portion 20. The opening 23 may have an inside diameter approximately equal to an outside diameter of the studs 16 and a depth that is longer than a length of the stud 16. More particularly, the stud attachment portion 20 may have an inside diameter that is about 0.010 inch to about 0.020 inch larger than the diameter of the stud 16.

It may be seen that the wheel guide 10 may be placed onto one of the studs 16. The wheel guide 10 may remain on the stud 16 while the mag wheel 12 is positioned so that the wheel guide 10 protrudes through one of its holes 13. The mag wheel 12 may then be pushed toward the hub 14. As the wheel 12 reaches the stud attachment portion 20, the hole 13 may become concentric with the stud 16. Wheel nuts 22 may be attached to the studs 16 which are not covered by the wheel guide 10. The wheel guide 10 may then be removed from the stud 16 and one of the wheel nuts 22 may be placed on that stud 16, thus completing mounting of the wheel 12 on the vehicle.

The wheel guide 10 may be provided with a tapered transition section 25 between the handle 17 and the stud attachment portion 20. This transition section 25 may be useful in guiding the hole 13 to become concentric with the stud 16. Ease of wheel installation may be further enhanced if two of the wheel guides 10 are employed during installation. Additionally the wheel guide 10 may be provided with a knurled end 18 so that the wheel guide 10 may be conveniently handled by an installer.

In another exemplary embodiment, shown in FIG. 6, a wheel guide 24 may comprise a stud attachment portion 26 with internal threads 28. The threads 28 may advantageously match threads of the studs 16. The wheel guide 24 may be particularly useful for mounting large and heavy ones of the wheels 12.

In still another embodiment, shown in FIG. 7, a wheel guide 34 may be shaped as a straight cylinder with a handle 19 having the same outer diameter as the stud attachment portion 20. The wheel guide 34 may constructed or fabricated at a relatively low cost because of its simple shape.

The wheel guides 10, 24 and 34 may be constructed with their respective stud attachment portions 20 or 26 having various outer diameters to accommodate various styles of the wheels 12. For example, the outer diameters of the stud attachment portions may be 7/16 inch, ½ inch, 9/16 inch, 12 millimeters (mm) or 14 mm.

It should be understood, of course, that the foregoing relates to exemplary embodiments of the invention and that modifications may be made without departing from the spirit and scope of the invention as set forth in the following claims.

What is claimed is:

1. A wheel guide for attaching a wheel to a vehicle with wheel nuts having aligning portions, the guide comprising a hollow cylindrical stud attachment portion having an outside diameter approximately equal to a diameter of the aligning portions of wheel nuts, the stud attachment portion having an opening with an inside diameter approximately equal to an outside diameter of a wheel mounting stud of the vehicle and a depth greater than a length of the stud.

2. The wheel guide of claim 1 further comprising:
a handle; and
a tapered transition section between the handle and the stud attachment portion.

3. The wheel guide of claim 2 wherein the handle has a knurled end.

4. The wheel guide of claim 1 further comprising a handle having an outer diameter the same as that of the stud attachment portion.

5. The wheel guide of claim 1 wherein the outer diameter of the stud attachment portion is about 0.010 inch to about 0.020 inch smaller than the diameter of the aligning portions of wheel nuts.

6. The wheel guide of claim 1 wherein the inside diameter of the stud attachment portion is about 0.010 inch to about 0.020 inch larger than the outside diameter of the stud.

7. A wheel guide for attaching a wheel to a vehicle with wheel nuts having aligning portions, the guide comprising a hollow cylindrical stud attachment portion having an outside diameter approximately equal to a diameter of the aligning portions of wheel nuts, the stud attachment portion having internal threads configured to engage with threads of a wheel mounting stud of the vehicle.

8. A method for mounting a wheel on a vehicle comprising the steps of:
providing for placement of a wheel guide on a wheel mounting stud of the vehicle;
providing for positioning the wheel so that the wheel guide passes through a hole of the wheel; and
providing for pushing the wheel on the guide so that all holes of the wheel overlie their respective wheel mounting studs and so that the holes are aligned concentrically with the studs.

9. The method of claim 8 wherein the wheel guide is placed onto the stud with a slidable engagement.

10. The method of claim 8 wherein the wheel guide is placed on the stud with a threaded engagement.
